(19) United States
(12) Patent Application Publication
(10) Pub. No.: US 2020/0280758 A1
(43) Pub. Date: Sep. 3, 2020

(54) DISTRIBUTED CAMERA NETWORK

(71) Applicant: JUMP CORPORATION PTY LTD, Osborne Park (AU)

(72) Inventors: Bernard William O'Rourkes, Osborne Park (AU); Kresimir Grofelnik, Osborne Park (AU)

(21) Appl. No.: 16/645,699

(22) PCT Filed: Sep. 10, 2018
(86) PCT No.: PCT/AU2018/050975

§ 371 Date: Mar. 9, 2020

(30) Foreign Application Priority Data
Sep. 8, 2017 (AU) 2017903660

(51) Int. Cl. H04N 21/43; H04N 21/4223; H04N 21/63; G06Q 50/00; H04N 21/414; H04N 21/218; H04L 29/08

(52) U.S. Cl. CPC H04N 21/4307; H04N 21/4223; H04N 21/632; H04L 67/104; H04N 21/41407; H04N 21/21805; G06Q 50/01

(57) ABSTRACT

A system (100) and method for multiple, distributed, participant devices (11) to image a scene. The multiple participant devices (11), each having a camera, communicate with each other over a network (13, 15, 17). A participant device (11) sends an invitation to other proximal participant devices (11), associated with potentially collaborating participants, to capture a participant selected event. The proximal participant devices (11) records further imagery of the participant selected event and the further imagery is transmitted to a server (19). The server (19) processes the further imagery by collating and sorting the imagery in a sequence to generate a compiled image sequence.

### TECHNICAL FIELD

This disclosure relates to a distributed camera network system and method for visual arts and the production of creative visual content. In particular, the disclosure relates to a system and method for multiple participants to co-operate in gathering imagery relating to a common subject and/or a common timeframe, and to produce a visual artistic work therefrom.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

WO96/19892 describes a method of gathering multiple images of a common subject, taken from different positions along a path extending around or along the subject. These images are processed in a sequence, in order to produce a motion picture/video which gives the impression that a single motion picture/video camera has panned around or along a frozen scene depicting the subject. WO96/19892 also teaches gathering the images along the path sequentially in time in order to produce a time-lapse motion picture/video which gives the impression that a single motion picture/video camera has panned around or along a moving scene.

The system described in WO96/19892 relied on having sufficient cameras closely spaced to each other that the resultant blurring smoothed the transition from frame to frame.

U.S. Pat. No. 9,595,127B2 describes the remote collaboration of a subject and a graphics object in a same view of a 3D scene where a second photographer is provided with guidance to position their camera to capture a view.

U.S. Pat. No. 8,213,749B2 synthesizes images of a locale to generate a composite image that provide a panoramic view of the locale, for example, a video camera moves along a street recording images of objects along the street. US patent application US20140085543A1 and U.S. Pat. No. 8,406,610B2 are both directed to synchronizing or overlapping video frames from different sources to generate a video compilation.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout the specification unless the context requires otherwise, the word “comprise” or variations such as “comprises” or “comprising”, will be understood to imply the inclusion of a stated element, integer or step, or group of elements, integers or steps but not the exclusion of any other element, integer or step or group of elements, integers or steps.

### SUMMARY OF INVENTION

A system for multiple, distributed, participant devices to co-operatively collaborate on imaging a scene, wherein the system comprises: a first participant device having a camera, a user control input, processor, memory, display and a network interface device to communicate, wherein the processor is configured to: receive, over a network, identifying data relating to potentially collaborating participants associated with one or more proximal participant devices; send, in response to operation of the user control input by a participant, an invitation over the network to the one or more proximal participant devices to capture a participant selected event; one or more proximal participant devices having respective camera, user control input, processor, memory, display and network interface device, wherein the respective processor is configured to: receive the invitation and display a user selectable prompt to accept the invitation: transmit an acceptance notification to the network based on selection of the user selectable prompt by a collaborating participant; record, with the respective camera, further imagery of the participant selected event; and transmit the further imagery, wherein the further imagery is received at a server, and wherein the server collates the imagery and sorts the imagery in a sequence based on one or more of: position and/or orientation of the participant device of the participant device associated with the further imagery; and recordal time associated with the further imagery, and wherein the server further generates a compiled imagery sequence based on the sequence of imagery.

In one example of the system, at least part of the network comprises a peer-to-peer network.

In another example of the system, at least part of the network includes the server connected via the internet.

In the system, the first participant device is further configured to: record, with the camera, imagery of the participant selected event; and transmit the imagery of the participant selected event to one or more of: (i) the server, wherein the server further collates and sorts the sequence of imagery to includes imagery recorded by the first participant device; and (ii) one or more proximal participant devices.

In the system, the invitation may include one or more of: a participant entered message at the user control input; a participant selected message from one or more text descriptions at the display; an audio message recorded; and imagery of the participant selected event recorded with the camera of the first participant device.

The system may further comprise the server, wherein the server is further configured to transmit the compiled imagery sequence to one or more of the first participant device, one or more proximal participant device, or other device(s) associated with the participant or collaborating participant(s).

There is also provided a system for multiple participants to co-operatively collaborate on imaging a scene;

said system comprising a plurality of participant devices, each of said participant devices having a camera, user control input, processor, memory, display, and networking capability to allow data to be shared via a network between said plurality of participant devices in a peer to peer network or via an external server;
each said processor running an application from said memory, said application accessing data from said network and storing in said memory, identifying data relating to potentially collaborating participants also running said application on proximal networked participant devices;
where said application may access said camera under control of a participant to record imagery of a participant selected event;
where said application may initiate an invitation under control of a said participant, and send said invitation via said network to potentially collaborating participants devices, said invitation including a said participant entered message selected from one or more of a text description, an audio message or said imagery;
where said invitation is displayed on the display of potentially collaborating participants devices with a user selectable prompt for said potentially collaborating participants to accept said invitation and become collaborating participants, and acceptance is transmitted via said network;
where said collaborating participants and optionally also said participant may record further imagery of said participant selected event;
where each item of further imagery and optionally also said imagery, said invitation and each said acceptance are transmitted via said network to said server;
wherein said server collates each item of further imagery and optionally also said imagery, and sorts each said imagery in a sequence based on position from which said imagery obtained and the time said imagery was obtained or a combination of both, and said server compiles a sequence of at least some of said imagery into a compiled imagery sequence. The compiled imagery sequence may be made available for download to said participant and said collaborating participants.

Preferably, said invitation has a unique identifier to allow tracking of said invitation, and association of imagery therewith. This allows multiple invitations to issue from different participants, and allows the server to track multiple participant selected events transmitted via said network and also participants to identify and download said compiled imagery sequence. In some examples, each potentially collaborating participant device receives a unique invitation with a unique identifier. In other examples, a group of potentially collaborating participant devices may receive an invitation with the same unique identifier.

Preferably said application is arranged to allow formation of groups of participant devices, and said application stores in memory, particulars of said groups. A group may be formed when an invitation is initiated and collaborating participants have accepted invitations. In addition, preferably for groups that have been formed, the group may be saved by the initiating participant, to allow speedier future interactions among the group members. Accordingly, once a group is established, further invitations can be issued for subsequent events, and they will issue to the same participants as previous events. Imagery may be acquired and a compiled imagery sequence prepared, whether or not the group has been saved.

In the system, where there is no network access available to communicate to the server, the application is adapted to form a peer to peer network among said participant devices, and the participant devices will retain said further imagery and optionally said imagery until network communication can be established with said server. Where there is network access available, either Wi-Fi or cellular, the imagery and further imagery may be uploaded directly to the server, subject to server availability in times of peak demand. In this arrangement, the unique identification number is important for tracking imagery identifying the participant selected event, to distinguish from other participant selected events.

Alternatively, or in addition to network connection to said server, preferably said participant devices establish said peer-to-peer network in order to exchange data relating to participant device identification, participant selected events, timing data for synchronisation and/or control of devices.

Preferably said participant devices are mobile smart devices and in each of said participant devices, said application can access contact data from said mobile smart device and store this with said identifying data.

Preferably said server conducts an analysis of data embedded in said further imagery and optionally said imagery, to extract at least one of position data, orientation data, and time data, and uses at least one of position data, orientation data, and time data to establish an order of processing said further imagery and optionally said imagery to compile said compiled imagery sequence. The data embedded in the imagery is collected by the participant devices and stored with the imagery. Time data is determined from the mobile smart device network. The position data may be established by GPS and Wi-Fi corrected location data, and the orientation data may be derived from an orientation sensor. Where a mobile smart device of the so-called smart phone type is the participant device, this data is collected and embedded as metadata in the imagery file that is stored by the device.

Preferably said server may be configured to analyse said further imagery and said imagery to identify common subject matter therein, and scale said further imagery and said imagery to produce individual scaled further imagery and imagery, and prepare said compiled imagery sequence from said scaled further imagery and said imagery.

The initial imagery sent with the invitation may form part of the compiled imagery sequence, or may be used to indicate the subject matter to participants, in which case the originating participant will become a collaborating participant and fresh imagery will be taken by the originating participant device and become part of the further imagery.

Preferably in one arrangement, said server is arranged to control timing of actuation of said camera in each participant device. In a more preferred arrangement where the participant devices operate in a peer-to-peer network, the initiating participant device controls timing of actuation of said camera in each other participant device, in which case the server receives the uploaded imagery and runs the steps described to form the compiled imagery sequence. In either arrangement, the user need merely hold and aim the camera at the intended scene, and the timing of the imagery capture will be controlled by the initiating participant's device. The timing may merely be to synchronise the imagery capture so that all imagery is taken at the exact same time (e.g. simultaneously), or to sequence the imagery capture.

In some examples, the server receives position and/or orientation data from the participant device(s) to determine a specified sequence to record imagery. This determined sequence is then used in the timing data sent to the participant devices to control the timing of recording the imagery from respective cameras (i.e. the sequence may be used to time the shutter of the cameras).

There is also provided a computer-implemented method for multiple, distributed, participant devices to co-operatively collaborate on imaging a scene, the multiple participant devices including a first participant device in communication with, over a network, one or more proximal participant devices, wherein the method comprises: receiving, over the network, in identifying data relating to potentially collaborating participants associated with one or more proximal participant devices; sending an invitation over the network to the one or more proximal participant devices to capture a participant selected event; receiving, over the network, an acceptance notification from one or more proximal participant devices; sending, over the network, a control signal to initiate recording of further imagery of the participant selected event with respective cameras associated with one or more proximal participant devices, wherein, the further imagery is received at a server to collate the imagery and sort the imagery in a sequence based on one or more of: position and/or orientation of the participant device of the participant device associated with the further imagery; and recordal time associated with the further imagery, and wherein the server further generates a compiled imagery sequence based on the sequence of imagery.

In the computer-implemented method, the control signal to initiate is associated with timing data to synchronise cameras to record simultaneously or in a specified sequence.

The computer-implemented method may further comprise: forming a peer-to-peer network between the first participant device and the one or more proximal participant devices, wherein the invitations are communicated over the peer-to-peer network; storing, in the memory of the first participant device and/or the proximal participant devices, the recorded imagery; wherein on establishing network communication with the server, the first participant device and/or the proximal participant devices send the recorded imagery to the server.

The computer-implemented method may further comprise receiving, from the server, the compiled imagery sequence.

There is also disclosed a non-transitory computer-readable medium comprising program instruction that, when executed, cause a processor of a participant device to perform the method described above.

### BRIEF DESCRIPTION OF DRAWINGS

A preferred embodiment of the invention, being a system for multiple participants to co-operatively collaborate on imaging a scene, will now be described with reference to the drawings, in which:

FIG. 1 is a view of a user participant device being a mobile smart device screen user interface to the system;

FIG. 2 is a schematic of system architecture of the embodiment;

FIG. 3 is a flowchart showing the process for timed media capture;

FIG. 4 is a flowchart showing the process for untimed media capture;

FIG. 5 shows how Positioning data is used to obtain a more accurate position of participant devices;

FIG. 6 is a view of the GUI of FIG. 1 showing user controls and displayed data;

FIG. 7 is a view of the GUI of FIG. 1 for the initiating participant's device;

FIG. 8 is a view of the GUI of FIG. 1 for all participant devices showing countdown to image capture;

FIG. 9 is a view of the GUI of FIG. 1 for collaborating participant devices confirming sharing of captured image;

FIG. 10a is a schematic example of proximally located participant devices recording imagery of a subject in a selected event

FIG. 10b is an example of a compiled imagery sequence generated from the recorded imagery from FIG. 10a;

FIG. 11a is an example of a recorded imagery;

FIG. 11b is an example of a 3D point cloud generated from recorded imagery in FIG. 11a; and

FIG. 12 is a schematic example of a processing device.

### DESCRIPTION OF EMBODIMENTS

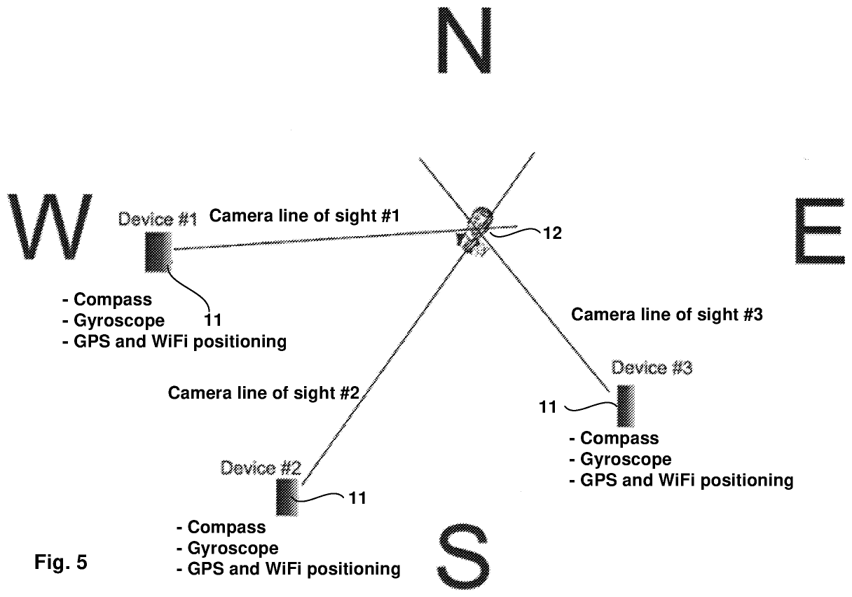

The preferred embodiment provides a system 100 and a method where multiple participants being mobile/cellular smart phone users can co-operatively collaborate on imaging a scene in order to produce imagery of that scene. The scene may be any visual event witnessed by a number of people from different vantage points, for example, at a sporting event, a concert, or some other cultural event. As example of this is shown in FIG. 5 where participant devices in the form of smart phones 11 which may be spaced around a subject 12, and will be able to photograph the subject from different angles and perhaps different elevations. That is, providing a network of participant devices to provide a distributed camera network, whereby captured images from different perspectives are used to compile an imagery sequence.

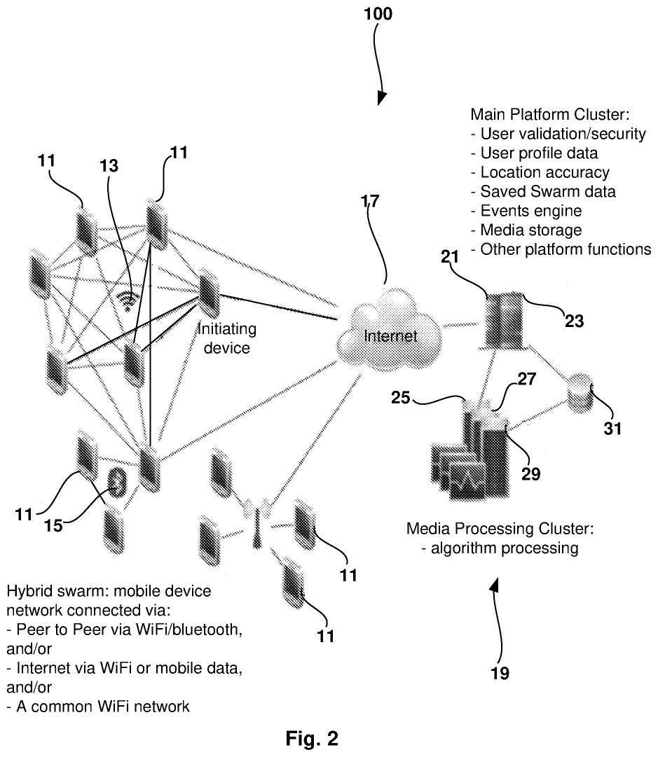

Referring to FIG. 2, a number of participant devices in the form of smart phones 11 are required in order to collaborate. These participant devices may be Apple iPhones, Samsung smart phones, or other devices running the Android OS or iOS, or equivalent. Each of the smart phones is essentially a pocket computer, having a camera, user control input which is typically a touch screen keyboard input (although other keyboards utilised in some devices s either as a standard feature or an after-market accessory may be present or utilised), memory to store data including applications and user contacts, a processor to run applications from memory, a display to interface visually to the user, and also networking capability to allow data to be shared via a network between the participant devices in a peer to peer network or via an external server, or both.

The participant devices are configured for the capture of still images and/or video, including (but not limited to) visual data and other metadata such as location, GPS positioning, relative device positioning, geomagnetic orientation, device orientation, timestamp, exposure settings including shutter speed, aperture, film speed ISO, spatial configuration including motion data (acceleration and rotational forces along 3 axes), environmental data (such as ambient air temperature and pressure, illumination, and humidity) relevant to the captured image(s) or video.

The networking capability is typically Wi-Fi 13, Bluetooth 15, and the mobile smart device network (e.g. cellular network), and facilitates further tasks across the connected devices.

In the case where there is no central wireless access point or internet connection, a structured peer-to-peer network is established using direct Wi-Fi and/or Bluetooth connection between devices. The connection type is dependent on device operating system.

In the case where a common wireless access point is available, the existing network infrastructure is used for communication.

In the case where a device has an available connection to the Internet 17, data exchange with the main platform server cluster 19 (back-end) is employed to further improve communication between devices using additional metadata stored in the back-end that has been accumulated from other connected devices, including device identifier, device orientation, gyro data, device location and image data.

In all cases, a fast Bluetooth LE connection is used to exchange lightweight real-time data between devices for high-speed synchronisation and optimal performance. Each device 11 is broadcasting its current application state and relevant information to its neighbours, so that the actual information exchange is connection-less and less prone to errors. Data exchanged includes device identifier, device orientation, gyro data, device location and active instance identifier (group id and creator) between nearby devices

The Connectivity platform is maintained by the mobile client application and is therefore able (where a peer-to-peer network can be established as described above) to exist between registered platform users independent of the primary platform server, with adaptive network sensing which ensures robust connectivity by switching connection method wherever possible if/as required.

Real-time data exchange is established between connected devices 11 as described above via Bluetooth LE and Wi-Fi, and (where appropriate) is used to synchronise device timing and determine suitable diagnostic settings for improved results, so as to facilitate execution of the synchronised group image capture, and reduce the margin of error that may occur as a result of inaccurate device sensor readings. This includes assisted GPS, with (where supported) gyroscope and compass to get a more accurate position of each device in space, (see FIG. 5) and Bluetooth LE to improve camera shutter synchronisation between multiple devices.

The external server 19 referred to is a backend server and stores particulars relating to participants who have downloaded applications (Apps) so that the individual participants can be identified. The User particulars stored comprise Unique user identifier, Name, Profile picture, Mobile phone, Email, Current location, Device type and device capabilities, Push notification token, Captured images

The external server 19 will in practise be a bank of networked computers 21, 23, 25, 27, 29 (a main platform server cluster), with storage 31 to store user details in addition to imagery captured by the users, and compiled imagery sequences being the product of the collaboration of participant devices, in addition to temporary data generated which will include temporary groups formed around an event. However, it is to be appreciated that the server 19 may include, in some examples, a single computer or computing device.

The external server 19 provides a platform configured to allow one or more participating users/agents to collaborate using shared captured content in the form of imagery and metadata associated therewith. The user can use the content arbitrarily, or alternatively platform algorithms can analyse the metadata collected for each captured item to assist users with combining this content in a visually effective manner. For example, an algorithm comparing metadata for the relative positions and angles of a synchronised group image capture can plot a path that allows a user to combine selected images as frames in a video to render a virtual camera motion effect. This allows for many creative approaches including (but not limited to) combining and sequencing images in any order to create, for example, virtual camera motion and time-sequenced effects for video, static or motion 3-dimensional imagery, a snapshot of a moment in time from a multitude of local/national/global perspectives, a common scene as captured by multiple users at different times, to produce a collaborative time-lapse of that scene, and other forms of as yet unidentified creative visual communication.

Information derived from sensors such as gyroscopes, magnetometers, and accelerometers in the participant device to assist in determining the camera position and orientation of the participant device and camera. For example, the magnetometers may assist in determining the direction, and hence, line-of-sight intersection of the multiple cameras. This can also improve the distance estimation of each camera to the participant selected event/subject. The gyroscope may further assist by detecting angular movement (i.e. rotation in pitch, yaw and roll) during recording from the camera. Accelerometers may also assist in determining movement as well as orientation. In some examples, such information may be provided in metadata associated with the imagery.

In further examples, device to device distance may be determined/estimated based on Bluetooth signal strength. This may be used to assist in determining relative distance between participant devices (with or without other information).

Each mobile smart device 11 runs an application from said memory, the application having been previously downloaded by the owner of the device. When run, the application sends login information identifying the user, and GPS coordinates identifying the user's location, to the server 19. The server 19 stores user identification data and GPS co-ordinates for each user in a table. The server 19 can track which users are active and logged in and can group users by location using this data, so that invitations can be targeted. The application accesses data from said network and data stored in said memory, identifying data relating to potentially collaborating participants/users that are also running the application on proximal networked participant devices by GPS location grouping. Via Bluetooth Lowe Energy (BLE) and (where available) Wi-Fi, each user reports their location to other connected device(s) and/or (where possible) to the primary backend server, so that already known users that are in their vicinity are shared thus notifying the reporting user of his peers. This shared table of nearby users is constantly updated and exchanged between users/peers, and (where possible) with the primary server, thus all users are sharing an frequently updated table of users in the group or peers as the primary means of maintaining connectivity.

In some examples, the networked participant devices may communicate based on a hierarchy of preferred network channels. This may include BLE, followed by Wi-Fi, and if not, relay messages via the backend server 19 (which may be deferred when network connection is re-established, and/or via other network means such as the internet and/or cellular data). This may be advantageous in times and location where there is high network demand such as during sporting and concert events.

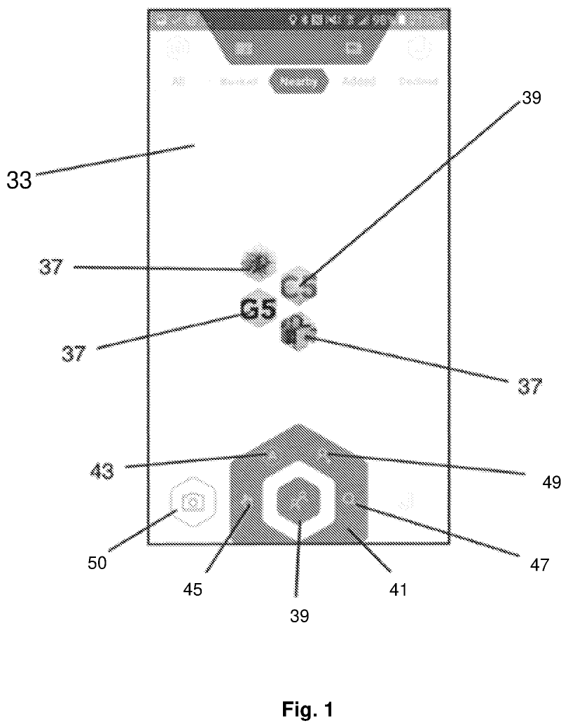

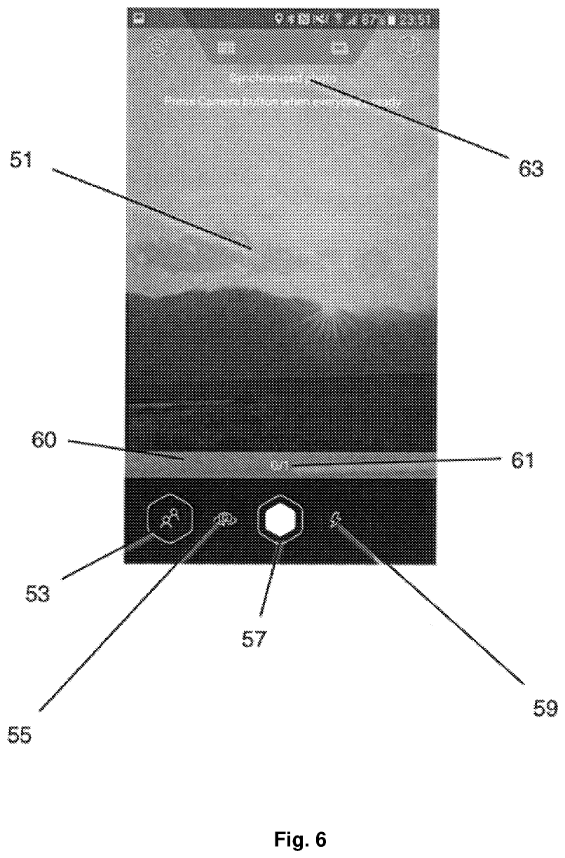

The application can access the camera in the mobile smart device and the user of the smart device can use the camera to record imagery, which may be a photograph or video of a participant selected event in the form of a scene. The application brings up a GUI screen 33 on the device's display where the user can complete an invitation which is associated with the recorded imagery. As an alternative to the recorded imagery, the invitation may include text entered by the user which identifies a subject being the imagery which intended participants are to be invited to capture (named group media capture). In a proximity view as shown in FIG. 1, the user of the device 11 has a user avatar 35, and other users within range have avatars 37. The GUI screen 33 in the proximity view has a central enter button 39. A long press-hold of the enter button 39 toggles a menu button 41 that appears around it. The menu button 41 shows buttons that carry out actions relevant to the users shown above on the main screen. A “select all” button 43 selects all users shown on the screen, an “individual select” button 45 allows individual users to be selected, a “search” button 47 allows the user to search for other users by name via a search popup which will appear on the screen 33 when selected, an “add user” button 49 allows the user to invite user(s) to the current group that are outside the immediate proximity range, e.g. via social media channels, address book etc. An “invite send” button 50 sends the invitation to the selected users and switches the GUI screen 33 to media capture view 51 shown in FIG. 6. The media capture view 51 shows imagery which is in the camera view of their device.

Invited users receive a popup invitation on their GUI screen 33, prompting each if they would like to participate in the named group media capture which is identified in the popup invitation. If an invited user accepts the invitation, and if they accept to become participants they are shown the media capture screen 51. The media capture screen 51 shows the user what is in view of their device camera. Group button 53 returns the user to the group screen 33. Flip camera button 55 toggles between device front and rear cameras (where available). Context button 57 executes the current task—for the initiator this will trigger the capture process, and for invited participants this will confirm their readiness for media capture. A long press of the context button 57 will show additional menu items relevant to the type of media capture, specifically—instant, timed, scheduled and location-anchored. Flash toggle button 59 toggles the device flash mode between on/off/automatic. For the initiator, a status bar 60 including a status indicator 61 shows number of ready users out of the total number of invited users. When the initiator presses the context button 57 to execute the current task, this event is communicated to the participants, who will see instructions to progress to the next step. Media capture title 63 shows the name of the current media capture instance, which can be the text entered by the user which identifies the imagery which intended participants are to be invited to capture (named group media capture).

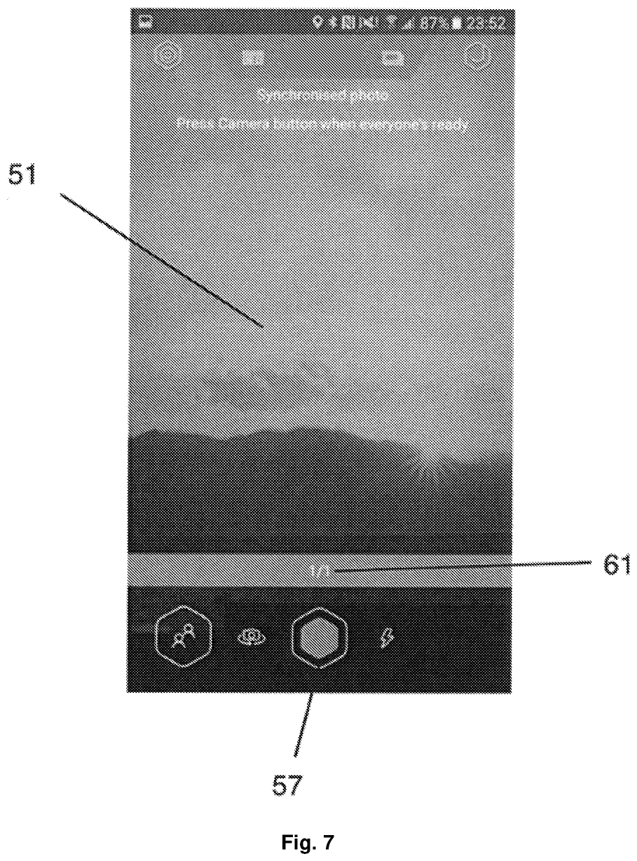

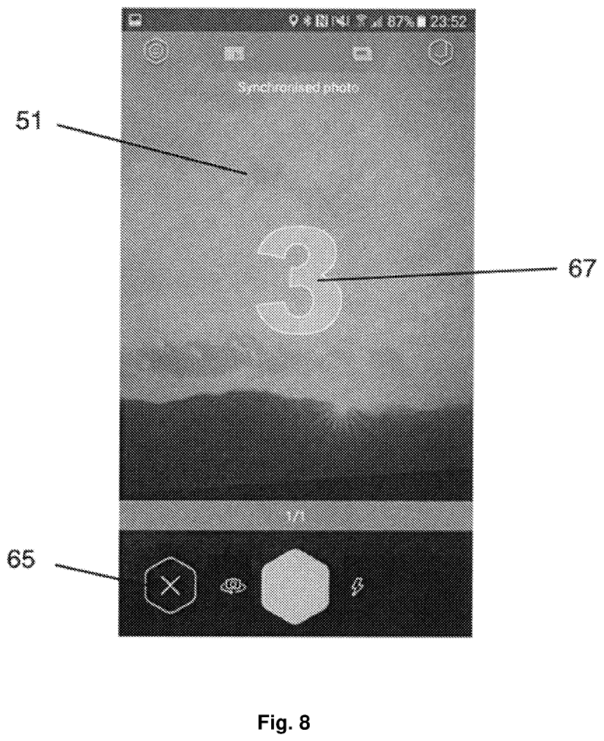

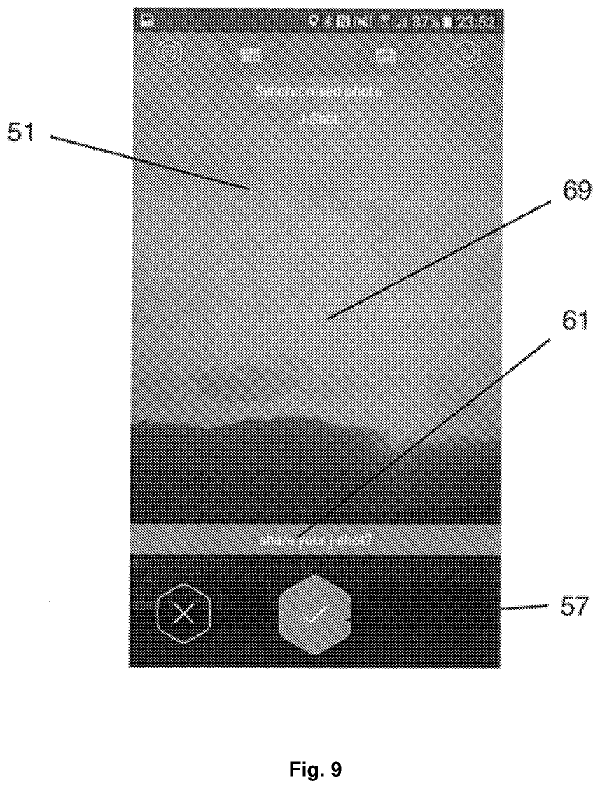

FIG. 7 shows the initiator's media capture screen 51 in a later state with all participants ready, indicated by a change in colour of the status bar 60 from grey to green, and the colour of the context button 57 also changing to green. When satisfied that they have enough or all participants, the initiator taps on the context button 57 to trigger start of the capture process. FIG. 8 shows a further state from with a prominent number 67 indicating remaining time in seconds until the actual media capture is triggered. As the timer counts down, the participant need only point their camera at the subject as identified in the invitation that they accepted. The user may cancel their participation by tapping the exit button 65. FIG. 9 shows the final state where the captured media 69 is shown to the user, and the user is prompted 61 to approve the new captured media for sharing within the group by tapping the “approve” context button 57 which has changed to the colour blue, to indicate that approval by the participant is required. When the captured media has been approved by the participant, it is uploaded to the server 19, subject to network availability. If the network is unavailable, the application will queue the upload to be completed later, when the network becomes available. The uploaded imagery will include all of the metadata associated with the image including identification data pertaining to the invitation, so that the server 19 can subsequently process all of the imagery associated with the particular invitation.

The user can select to broadcast an invitation as a message within the application to a selected group of friends or contacts, or to all users with the application within proximity as determined by GPS grouping. The user can select via a wheel control on the GUI, the maximum distance range within which participants may be from the user. The invitation is sent to the users with a unique identifier and a short title/description of the subject, so the users will know what the subject matter of the selected event is.

The application then displays the message as an invitation to the other users, who by selecting a prompt can opt in to participate, or opt out. If any user does not respond to the message within a predetermined time, the displayed message times out and is treated as an opt-out. At the end of the predetermined time, the status bar 60 will change to green to indicate all participants are ready.

When users select to opt in, acceptance is transmitted via the network to the initiating user, who has a visual indication on his screen showing the number of participants as a percentage of the total participants invited. The Initiating user may cancel at any time, in which case all participants will receive a notification to inform them of the cancellation. The initiating user may trigger the group capture at any time by pressing the context button 57, regardless of the number of accepted participants. When the shot is triggered, each participating device is sent the trigger event, which prompts a synchronised countdown on each participant user's screen. On countdown completion, the participant devices perform the synchronised capture.

On acceptance of the invitation to participate, the application clock is synchronised locally for each participant device relative to the initiating user's device to facilitate simultaneous timing across all participant devices. This is done by broadcasting a BLE clock reset packet to each participant upon which they reset their internal clock to zero. This method ensures enough precision for camera synchronization.

The initiating user and the collaborating participants who have opted in can record further imagery of the user selected event.

Once the further imagery is recorded it is stored on the user devices and uploaded by the application with the associated unique identification number via Wi-Fi or the cellular data network, and stored on the server.

The server collates each item of further imagery and sorts it in a sequence based on position from which said imagery obtained and the time said imagery was obtained or a combination of both. The server compiles a sequence of at least some of the imagery into a compiled imagery sequence which may form a short movie sequence of stills. The compiled imagery sequence may be made available for download to said participant and said collaborating participants.

Since the invitation contained a unique identifier (for example a unique identification number) to allow tracking of said invitation, and association of imagery therewith, multiple invitations issued from different participants can be handled, and the server can track multiple collaborative events, and also participants can correctly identify and download said compiled imagery sequences relating to collaborative events that they have participated in.

The application is arranged to allow formation of groups of participant devices, and the application stores in memory, particulars of the groups. A group may be formed when an invitation is initiated and invitations have been accepted by collaborating participants. The group may be stored at the election of the initiating user, for future recall. Accordingly, once a group is established and stored, further invitations can be issued for subsequent events, and they will issue to the same participants as previous events.

In the system, where there is no network access available to communicate to the server, the application is adapted to form a peer-to-peer network among said participant devices, and the participant devices will retain the further imagery and optionally the originating imagery until network communication can be established with said server. Where there is network access available, either Wi-Fi or cellular, the imagery and further imagery may be uploaded directly to the server, subject to server availability in times of peak demand. In this arrangement, the unique identification number is important for tracking imagery identifying the participant selected event to distinguish from other participant selected events.

The unique identification number associated with each message can also assist with messages that are transmitted (and retransmitted) on multiple communication channels. This may occur, for example, where the message is retransmitted over a different communication layer or channel because the currently used channel is not available anymore (e.g. if the device is out of Bluetooth range and the engine switches over to Wi-Fi). By having a unique identification number, such retransmitted messages are easily detected and the device can ignore the duplicate message.

Alternatively, or in addition to network connection to said server, preferably said participant devices establish said peer-to-peer network in order to exchange data relating to participant device identification, participant selected events, timing data for synchronisation and/or control of devices.

The most preferred participant devices are cellular telephones and in each of these participant devices, the application can access contact data from said cellular phone and store this with said identifying data. Tablets and iPads having cellular network access or at least ad hoc network access via Wi-Fi or Bluetooth, and having contact data, and other networkable camera-equipped devices can be used equally effectively.

The server may conduct an analysis of data embedded in said further imagery and optionally said imagery, to extract at least one of position data, orientation data, and time data, and uses at least one of position data, orientation data, and time data to establish an order for processing the further imagery and optionally said imagery to compile the compiled imagery sequence. The data embedded in the imagery is collected by the participant devices and stored with the imagery. Time data is determined from the mobile smart device network, or as previously described when there is no cellular network available. The position data may be established by GPS and Wi-Fi corrected location data, and the orientation data may be derived from an orientation sensor. Where a mobile smart device of the so called smart phone type is the participant device, this data is collected and embedded as meta data in the imagery file that is stored by the device.

The server may be configured to analyse said further imagery and said imagery to identify common subject matter therein, and scale said further imagery and said imagery to produce individual scaled further imagery and imagery, and prepare said compiled imagery sequence from scaled further imagery and said imagery. This can standardise the size of the subject as captured by different participating devices, resulting in a smoother compiled imagery sequence.

The initial imagery sent with the invitation may form part of the compiled imagery sequence, or may be used to indicate the subject matter to participants, in which case the originating participant will become a collaborating participant and fresh imagery will be taken by the originating participant device and become part of the further imagery.

The initiating user triggers the media capture, controlling the timing of actuation of said camera in each participant device. In this manner, the user need merely hold and aim the camera at the intended scene, and the timing of the media capture will be controlled by the timer in the participating device, as triggered by the initiating user.

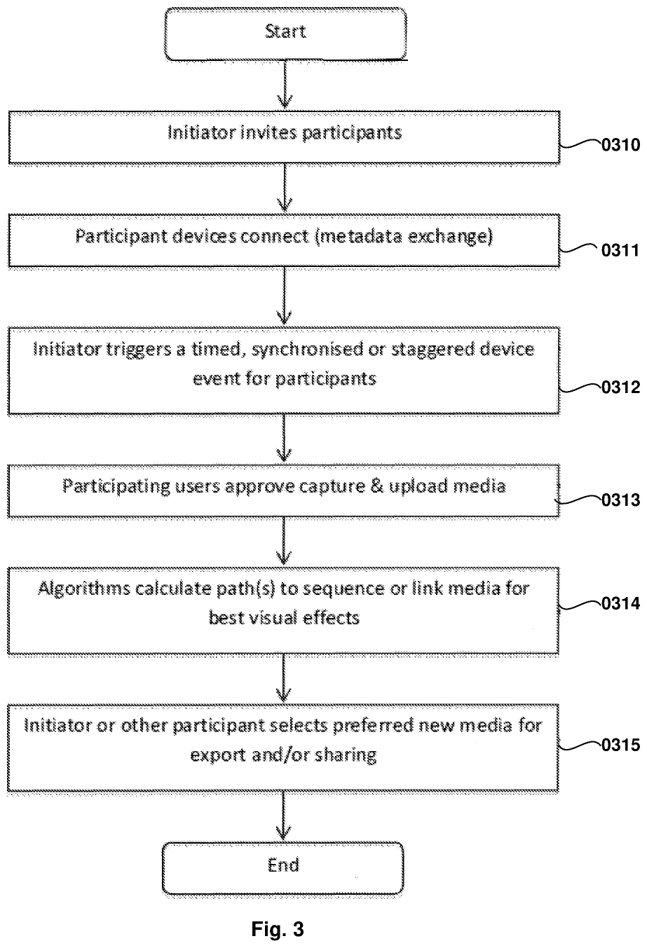

Referring to FIG. 3, the flowchart for a timed media capture is shown. A timed media capture allows users to orchestrate synchronised, timed, staggered and/or other functions for media capture and other events across participating connected devices. Further details for each step of the process in FIG. 3 are outlined below.

At step 0310, the initiating user creates a new instance via the mobile client application. The Connectivity platform enables the initiator to select and invite members from their social network(s) and/or other people already using the platform to be participants in the instance. The platform allows the initiator to restrict or extend the level of visibility so that for example, users outside the initiator's immediate social networks may also opt-in to participate.

At step 0311, as invitees agree to participate, their devices are networked using one (or a combination of) the methods outlined above. Real-time data exchange is established between the participants to facilitate execution of the selected function(s).

At step 0312, the initiator uses the mobile client application to trigger a timed, synchronised, staggered or otherwise orchestrated event to all participating devices—in this instance, it is to initiate a media capture.

At step 0313, each user must approve their captured media (users may elect for this to be an automated process). Once approved, media is queued for uploading to the primary server. If no Internet connection is available, media remains queued locally on the capturing device for upload whenever a suitable connection is established.

At step 0314 algorithms calculate path(s) to sequence or link media for best visual effects Metadata attached to each media item includes (but is not limited to):
Device location
Relative and absolute positioning
Device orientation
Media capture data including shutter speed and aperture
Other diagnostic information
   The algorithms iteratively use one or more of the above metadata to produce one or more resulting outputs. The fewer media items there are to sequence, the less metadata iterations are required as there is often only a single obvious path to produce a result. An example pseudo-method is as follows:
1. Compare device locations to plot most evenly spaced path(s) (subset 1)
2. Compare relative positions from subset 1 to then i) sequence suitable ordering and ii) plot usable path(s) (subset 2)
3. For each media item from subset 2—i) establish field of view from device orientation metadata, and ii) compare each for similarities to plot “most even” path(s) (subset 3)
4. Compare capture data for each media item from subset 3 to exclude any aberrant items
5. Display final sequenced media subsets on timelines for user to view, manually edit or render for final output.

At step 0315, permitted users can select preferred new media for export and/or sharing. Users that have been granted permission by the initiator select their preferred version(s) and initiate the process to render the new media into a usable output format for export or sharing.

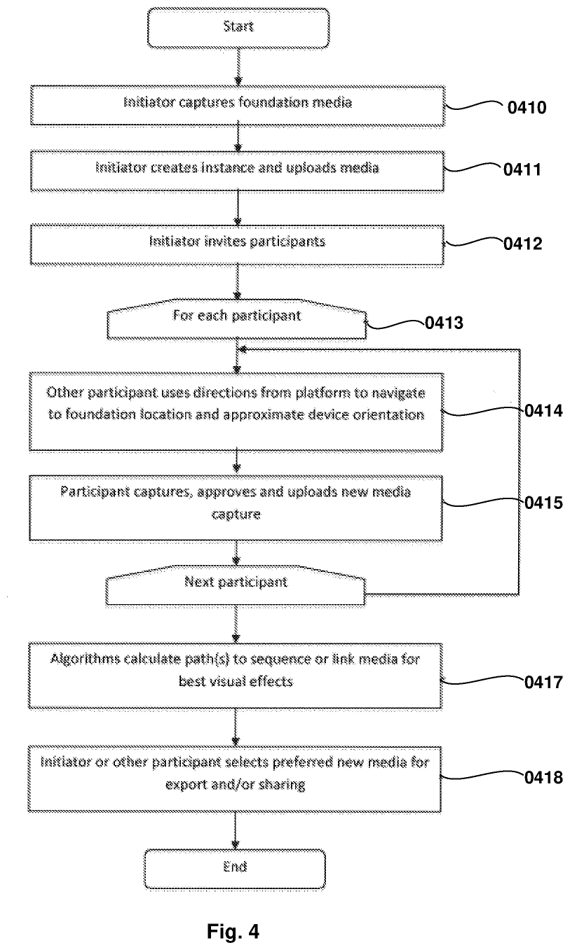

Referring to FIG. 4, an untimed media capture is another example application of the embodiment. Users can orchestrate a “foundation” media capture that can easily be imitated and re-created arbitrarily by other devices connected to the platform, using metadata from the foundation media. Further details for each step of the process in FIG. 4 are outlined below.

At step 0410, a platform user (initiator) makes a “foundation” media capture. The metadata taken from the foundation media is used as the basis for the following steps in this method.

At step 0411, the initiator creates a new instance via the mobile client application, defines its required parameters then saves it to the platform and in doing so approves the foundation media to be queued for uploading to the primary server. If no Internet connection is available, the instance and media remain queued locally on the capturing device for upload whenever a suitable connection is established.

At step 0412, the initiator invites participants. The Connectivity platform enables the initiator to select and invite members from their social network(s) and/or other people already using the platform to be participants in the instance. The platform allows the initiator to restrict or extend the level of visibility so that for example, users outside the initiator's immediate social networks may also opt-in to participate.

An iteration 0413 commences for each participant. At step 0414, the participant uses directions from platform to navigate to the foundation media location and approximate device orientation. The platform sends directions to the participant's mobile client application, for the participant to follow so that they can navigate to the location and approximate their device's orientation to be similar to that of the foundation media. At step 0415, the participant captures media on their device. The user must approve the captured media and then it is queued for uploading to the primary server. If no Internet connection is available, media remains queued locally on the capturing device for upload whenever a suitable connection is established.

Once all participants have completed uploading captured media, or if a predetermined timeout period is reached, the system begins media processing.

Step 0417 shows the process followed when the uploaded imagery is to be processed. Algorithms calculate path(s) to sequence or link media for best visual effects. Metadata attached to each media item includes (but is not limited to):
Device location
Relative and absolute positioning
Device orientation
Media capture data including shutter speed and aperture
Other diagnostic information

Algorithms iteratively use one or more of the above metadata to produce one or more resulting outputs. The fewer media items there are to sequence, the less metadata iterations are required as there is often only a single obvious path to produce a result.

An example pseudo-method is described below:
1. Compare device locations to plot most evenly spaced path(s) (subset 1)
2. Compare relative positions from subset 1 to then i) sequence suitable ordering and ii) plot usable path(s) (subset 2)
3. For each media item from subset 2—i) establish field of view from device orientation metadata, and ii) compare each for similarities to plot “most even” path(s) (subset 3)
4. Compare capture data for each media item from subset 3 to exclude any aberrant items
5. Display final sequenced media subsets on timelines for user to view, manually edit or render for final output.

At step 0418, permitted users can select preferred new media for export and/or sharing. Users that have been granted permission by the initiator select their preferred version(s) and initiate the process to render the new media into a usable output format for export or sharing.

Any user can specify for their device to automatically accept invitations from any other user, and furthermore to also proceed to the “ready” state automatically. This allows for setups so that unattended devices can be triggered for media capture without the need for user interaction.

### Example

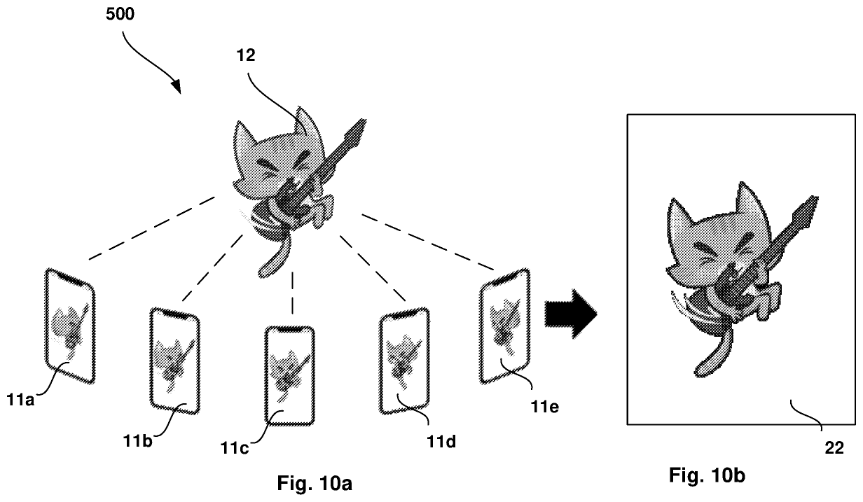

Another example implementation of the system and method is described below with reference to FIGS. 10a and 10b.

In this example, a compiled imagery sequence, in the form of a short video 22, is compiled in a 3d-style from photos captured by multiple smart-phone (participant devices 11a, 11b, 11c, 11d, 11e) from different perspectives, typically (but not restricted to) the same subject 12. Individual photos are synchronously captured by multiple users in different positions, with the “Initiator” associated with the first participant device 11a triggering the camera capture. Each of the captured imagery is then processed at the server 19 to sequence and position them as frames in the short video 22.

The resulting video file can also have leading and trailing video added, be looped and have other post-processing effects applied to it, allowing the creation of visually compelling content.

### (i) Capture Process

The participant may initiate the capture process through the first participant device 11a by selecting the participant selected event and providing other configuration inputs. This may include:
Selection of other potential participants for collaboration. This may include selecting a list of users, or from a list of users, to invite for participation for collaboration for the event instance.
Entering a short description of the participant selected event instance. For example, “Guitarist on stage”.
A reference image. The initiator may take an indicative photo that is sent to the invitees as a visual reference for the subject 12 they are planning to capture. This reference image may be recorded by the initiating participant's first participant device 11a.
Initial camera settings, such as flash mode, front/rear camera, timer settings, etc.
Privacy settings for the images and the compiled imagery sequence (such as the final output video).

### (ii) Invitation and Acceptance of Participants

Upon creation of an event instance, via the platform, the initiator sends a notification to prospective participants inviting them to take part in the collaboration. Invitees receive the details for the even instance and opt to accept or reject the invitation. The initiator is given real-time feedback of participant acceptance.

(iii) Synchronisation of Participants

Participant devices 11a, 11b, 11c, 11d, 11e communicate and pass required data to the first participant device 11a of the initiator using Bluetooth and Wi-Fi. A pre-focus event is triggered 1 second prior to the shutter event to prevent delays and give more accurate synchronisation. This may include having the cameras of the participant devices focusing on the subject 12 before the shutter event. This may also include adjusting exposure settings, aperture settings, and other settings.

### (iv) Synchronised Capture

In one example, the initiator may trigger the shutter event by operating a user control input on the first participant device 11a. At the other proximally located participant devices 11b, 11c, 11d, 11e, the display may show a countdown for the collaborating participants. The shutter capture event (i.e. recording the imagery) is then synchronised across all the devices 11a, 11b, 11c, 11d, 11e. It is to be appreciated that in other examples, the shutter event may be in a specified sequence so that some of the devices may have a shutter event at different respective times.

### (v) Post Shot

The participants are then presented with a preview of their captured image on the display of their respective participant device 11 for their approval or rejection. Upon acceptance, each participant device 11 uploads the image to the server 19 for processing.

### (vi) Pre-Processing

In some examples, the images, or thumbnails of the images, may also be sent to the initiator's first participant device 11a. The initiator may select, or deselect, any of the images based on suitability or unsuitability. The initiator may also select the image that has the most complete view of the scene as the primary image. The initiator may also select an area of the primary image for cropping to remove superfluous parts of the image. The initiator may also select focal points, which may be points (for example, two points) on the screen that should be the most likely to be matched across all images for alignment. The first participant device 11a may then send this data to the server 19 for processing, which will be discussed in further detail below.

(vii) Source Image Storage

The imagery may be stored by the server 19 in storage 31. In some examples, the storage may include cloud based storage. This may include using third party storage solutions to allow efficient data access worldwide. The imagery may be stored at full-resolution. In some examples, low-resolution versions may also be used for better performance.

(viii) Cropping/Limiting Work Area

The initiator may have the option to select an area of the primary image for cropping. As this cropped area has been designated by the initiator as the important area, all pixels outside this area may be ignored during processing. The reduced working area increases speed and efficiency of processing as there is less image data to be processed.

### (ix) Sequence Order and Photogrammetric Extrapolation

The participant device's GPS location data may be used for initial positioning. This may be embedded in the metadata of the imagery. Although GPS location data may have errors in some situations (such as built up areas or indoors), this may be useful in outdoor locations where GPS precision is at its maximum. The device camera information is extracted from the EXIF metadata, and by identifying common features between image pairs, this data can be processed through a Structure-From-Motion algorithm to extrapolate the relative spatial position of each participant device/camera 11. When all the participant device/camera 11 positions (and/orientations) are known, each of the images are ordered based on the corresponding participant device/camera X coordinate from lowest to highest value. It is to be appreciated that this is one example, and other specified ordering rules may be used.

### (x) Extrapolate Points for (Virtual) 3D Scene Recreation

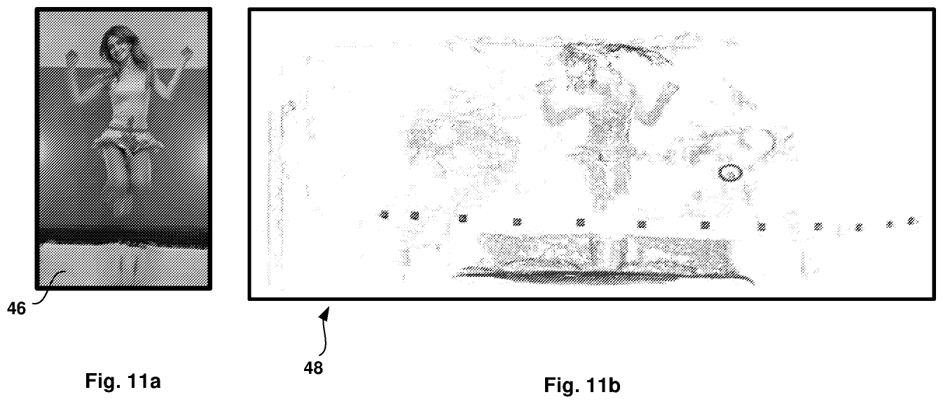

The Structure-From-Motion algorithm creates a point cloud of common points identified across the taken images. FIG. 11a illustrates one image 46 from a multiple recorded images. FIG. 11b illustrates a 3D point cloud 48 generated from the multiple recorded images. Additional steps may be performed to enrich the cloud (if necessary) with more points to recreate a dense 3D scene.

### (xi) Focal Points (Relevant to Yaw Motion Around Y Axis)

The initiator may opt to specify focal points on the primary image. Two points are selected on the screen that should be the most likely to be matched across all images for alignment. The default focal points may be shown on the relevant mobile app screen as a vertical line in the centre of the primary image. The initiator may change these points by drawing a line across the key points of interest. The algorithm may attempt to match the focal points across all the images, in effect giving an anchor point for all images and simplifying the alignment process. Correction on Y-axis may be done via overlapping focal points by moving the image up or down.

(xii) Align Frames X, Z Axes

Once focal point alignment is matched across each of the images, the X (left to right) axis and Z (backward to forward) axis also need to be aligned. Based on the distance between focal points, each image is corrected to match the Z-position of the primary device (image scaling). Correction on X-axis is done via overlapping the focal points by moving image left or right.

(xiii) Video Render

Once the images are aligned, the video (the compiled imagery sequence) is rendered from the frames and stored in storage 31. This may then be retrieved by the participant device(s) 11 for viewing. In other examples, the video may be pushed to the participant device(s) 11.

(xiv) Filtering

A video smoothing filter may be applied to the video. This may be applied automatically at the server 19. In other examples, the initiator may request a filter via the first participant device 11a. In further examples, additional video filter libraries may be used for post-processing.

### Other Considerations

In addition to the inputs provided by the initiator through the first participant device 11a (e.g. identity of participants, crop and focal points, etc.) other information may be collected at the proximal participant devices 11b, 11c, 11d, 11e. This may include EXIF data saved in each image, including GPS location, device orientation, camera focal length, camera type, camera model, shutter setting, aperture setting, ISO setting(s) associated with the image.

In some examples, three or more proximally located participant devices, capturing respective imagery, are used to provide results of acceptable quality.

In some examples, participant devices are proximally located within 100 metres of the initiator's first participant device 11a to provide higher performing results. This is a radius limit for some implementations of Bluetooth although it is to be appreciated this can vary from device to device and other factors such as output of the transmitter, sensitivity of the receiver, physical obstacles in the transmission path, device antenna and environmental factors.

In some examples, the pitch difference between devices should be less than 5 degrees. In some examples, the yaw angle between adjacent devices should be less than 20 degrees.

In some examples, the optimal distance to the subject may be between two to five metres.

In some examples, the subject occupies at least 60% of the imagery to provide optimal results.

In some examples, the determined position of the devices and subject should have a variance not more than one metre from the true positions.

### Network of Participant Devices

In some examples, a plurality of purpose-built participant devices 11 may be located at the scene. For example, an event organiser may arrange a networked plurality of participant devices 11 at a stadium or concert hall. The participant devices 11 may be accessible by users/patrons (free or for a fee) so that a patron can use the participant devices at the scene to direct cameras and create content. Thus live imagery may be captured as the action takes place and discoverable by patrons using the application on their personal mobile communication device. In some examples, users are able to register in a queuing/scheduling system and then execute their participant selected event using the application on their mobile communication devices. The devices may be natively link directly to servers for processing, with monetisation options such as a paid “pro” plan tailored to high volume users (i.e. events, venues etc.).

In an alternative application, the captured imagery may be used to create a 3D scene (which may be derived from the 3D point cloud). This data may then be used in virtual reality (VR) or augmented reality (AR) applications. For example, a VR application may include creating a 3D model of moments (or periods) of time that can be recreated or explored in a VR environment. Alternatively, in an AR application, the subject of a scene could be shown in place so that users can see and event/person/scene layered over their surroundings using their device. In one example of an AR application, this may include layering a performance or speech into a surrounding environment (e.g. recreating an AR performance at a stage after the performer has left the venue, to recreate the experience for users in the future).

### Example of a Processing Device

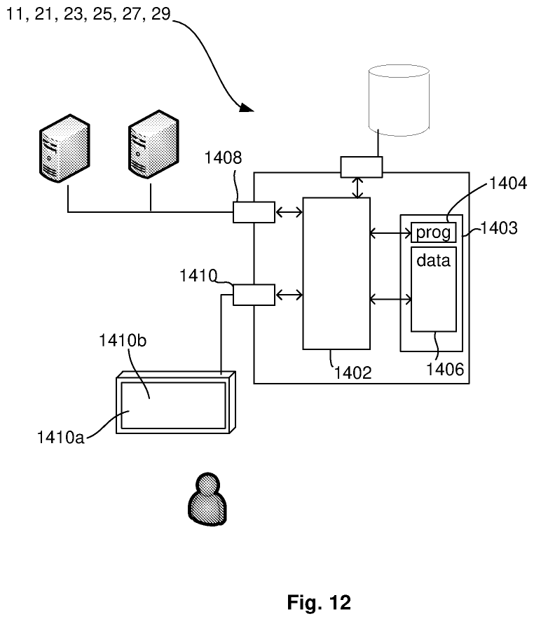

FIG. 12 illustrates an example processing device. The processing device may be one or more of the nodes in the system 100 disclosed herein, such as participant devices 11 (such as a mobile communication device) and computers 21, 23, 27, 29. As shown in FIG. 12, the processing device may include a processor 1402, a memory 1403, a network interface device 1408, and a user interface 1410 (which may include a user control input 1410a and/or a display 1410b). The memory can store instructions 1404 and data 1406, and the processor can perform the instructions from the memory to implement the processes as described herein.

The embodiments can include computer-executable instructions, such as routines executed by a general or special-purpose data processing device (e.g., a server or client computer). The instructions can be stored in a non-transient manner or distributed on tangible computer-readable media, including magnetically or optically readable computer discs, hard-wired or pre-programmed chips (e.g., EEPROM semiconductor chips), nanotechnology memory, biological memory, or other data storage media.

The data may be provided on any analog or digital network (e.g., packet-switched, circuit switched, or the like). The embodiments can be practiced in distributed computing environment where tasks or modules are performed by remote processing devices, which are linked through a communications network, such as a Local Area Network (“LAN”), Wide Area Network (“WAN”), or the Internet. As discussed above the network, in some examples, may also include peer-to-peer networks and combination thereof with client-server networks. In some examples, the network may also include communication with protocols including Bluetooth and Bluetooth Low Energy, although it is to be appreciated that other protocols may be implemented in other examples.

Those skilled in the relevant art will recognize that portions of the described technology may reside on a server computer, while corresponding portions reside on a client computer (e.g., PC, mobile computer, tablet, or smart phone).

The processing devices may include a personal computer, workstation, phone, or tablet, having one or more processors coupled to one or more memories storing computer-readable instructions. The various devices can be communicatively coupled in a known manner as via a network. For example, network hubs, switches, routers, or other hardware network components within the network connection can be used.

In general, the description of embodiments of the software and/or hardware facilities is not intended to be exhaustive or to limit the technology to the precise form disclosed above. While specific embodiments of, and examples for, the technology are described above for illustrative purposes, various equivalent modifications are possible within the scope of the software and/or hardware facilities, as those skilled in the relevant art will recognize. The teachings of the software and/or hardware facilities provided herein can be applied to other systems, not necessarily the system described herein. The elements and acts of the various embodiments described herein can be combined to provide further embodiments.

Having described the embodiment and a couple of different applications, it will be apparent to a person skilled in the art, that other variations can be implemented in order to capture different media such as video footage for example. It should be appreciated that the scope of the invention is not limited to the specific embodiment described herein.

1. A system (100) for multiple, distributed, participant devices to co-operatively collaborate on imaging a scene, wherein the system comprises:
a first participant device (11) having a camera, a user control input (1410a), processor (1402), memory (1403), display (1410b) and a network interface device (1408) to communicate, wherein the processor (1402) is configured to:
receive, over a network (13, 15, 17), identifying data relating to potentially collaborating participants associated with one or more proximal participant devices (11);
send, in response to operation of the user control input (1410a) by a participant, an invitation over the network (13, 15, 17) to the one or more proximal participant devices (11) to capture a participant selected event;
one or more proximal participant devices (11) having respective camera, user control input, processor, memory, display and network interface device, wherein the respective processor is configured to:
receive the invitation and display a user selectable prompt to accept the invitation:
transmit an acceptance notification to the network (13, 15, 17) based on selection of the user selectable prompt by a collaborating participant;
record, with the respective camera, further imagery of the participant selected event; and
transmit the further imagery,
wherein the further imagery is received at a server (19), and wherein the server collates the imagery and sorts the imagery in a sequence based on one or more of: position and/or orientation of the participant device (11) of the participant device associated with the further imagery; and recordal time associated with the further imagery, and wherein the server further generates a compiled imagery sequence based on the sequence of imagery.

2. A system (100) according to claim 1 wherein at least part of the network (13, 15, 17) comprises a peer-to-peer network (13, 15).

3. A system (100) according to claim 1, wherein at least part of the network (19) comprises includes the server (19) connected via the internet (17).

4. A system (100) according to any one of the preceding claims wherein the first participant device (11) is further configured to:
record, with the camera, imagery of the participant selected event; and
transmit the imagery of the participant selected event to one or more of:
(i) the server (19), wherein the server (19) further collates and sorts the sequence of imagery to includes imagery recorded by the first participant device; and
(ii) one or more proximal participant devices (11).

5. A system (100) according to any one of the preceding claims wherein the invitation includes one or more of:
a participant entered message at the user control input (1410a);
a participant selected message from one or more text descriptions at the display (1410b);
an audio message recorded; and
imagery of the participant selected event recorded with the camera of the first participant device.

6. A system (100) according to any one of the preceding claims, wherein the system (100) further comprises:
the server (19), wherein the server is further configured to transmit the compiled imagery sequence to one or more of the first participant device (11), one or more proximal participant device (11), or other device(s) associated with the participant or collaborating participant(s).

7. A system for multiple participants to co-operatively collaborate on imaging a scene;
said system comprising a plurality of participant devices, each of said participant devices having a camera, user control input, processor, memory, display, and a network interface device to allow data to be shared via a network between said plurality of participant devices in a peer to peer network or via an external server; each said processor running an application from said memory, said application accessing data from said network and storing in said memory, identifying data relating to potentially collaborating participants also running said application on proximal networked participant devices;
where said application may access said camera under control of a participant to record imagery of a participant selected event;
where said application may initiate an invitation under control of a said participant, and send said invitation via said network to potentially collaborating participants devices, said invitation including a said participant entered message selected from one or more of a text description, an audio message or said imagery;
where said invitation is displayed on the display of potentially collaborating participants devices with a user selectable prompt for said potentially collaborating participants to accept said invitation and become collaborating participants, and acceptance is transmitted via said network;
where said collaborating participants and optionally also said participant may record further imagery of said participant selected event;
where each item of further imagery and optionally also said imagery, said invitation and each said acceptance are transmitted via said network to said server;
wherein said server collates each item of further imagery and optionally also said imagery, and sorts each said imagery in a sequence based on position from which said imagery obtained and the time said imagery was obtained or a combination of both, and said server compiles a sequence of at least some of said imagery into a compiled imagery sequence.

8. The system according to claim 7, wherein the compiled imagery sequence is made available for download to said participant and said collaborating participants.

9. The system according to any one of the preceding claims wherein the invitation is associated with a unique identifier to allow tracking of the invitation and associated imagery.

10. The system according to any one of the preceding claims wherein the participant device is configured to:
receive a selection from the user control input to form a group of participant devices; and
store, in the memory, particulars of the participants in the group,
wherein the particulars of the participants are stored to identify potential collaborating participants for a subsequent participant selected event.

11. The system according to any one of the preceding claims wherein if the first participant device and/or the proximal participant devices determine network communication with the server is not available, the system further configured to:
form a peer-to-peer network between the first participant device and the one or more proximal participant devices, wherein the invitations are communicated over the peer-to-peer network;
store, in the memory of the first participant device and/or the proximal participant devices, the recorded imagery;
wherein on establishing network communication with the server, the first participant device and/or the proximal participant devices send the recorded imagery to the server.

12. The system according to any one of the preceding claims, wherein the server is configured to:
analyse data associated with the further imagery, and/or imagery, to extract at least one of position data, orientation data, and time data;
determine, based on the at least one of position data, orientation data, and time data, an order to process the further imagery, and/or imagery, to generate the compiled imagery sequence.

13. The system according to any one of the preceding claims wherein the server is configured to:
analyse data associated with the further imagery, and/or imagery, to identify at least one common subject; and
scale further imagery, and/or imagery, to produced scaled further imagery, and/or imagery, of the at least one common subject,
wherein the compiled imagery sequence is based on the scaled further imager, and/or imagery.

14. The system according to any one of the preceding claims further comprising:
communicating, between the first participant device and one or more proximal participant devices, timing data for synchronisation and/or control of the participant devices.

15. The system according to any one claims 1 to 13 wherein the server is configured to:
send, over the network, timing data for synchronisation and/or control of the participant devices.

16. The system according to claim 15, wherein the server is further configured to:
receive position and/or orientation data from the participant devices;
determine a specified sequence to record imagery from respective cameras of the participant devices; and
determine timing data based on the specified sequence to record imagery.

17. The system according to either claim 14 or 15 wherein timing data includes synchronising cameras to record simultaneously or in a specified sequence.

18. A computer-implemented method for multiple, distributed, participant devices to co-operatively collaborate on imaging a scene, the multiple participant devices including a first participant device in communication with, over a network, one or more proximal participant devices, wherein the method comprises:
receiving, over the network, in identifying data relating to potentially collaborating participants associated with one or more proximal participant devices;
sending an invitation over the network (13, 15, 17) to the one or more proximal participant devices (11) to capture a participant selected event;
receiving, over the network, an acceptance notification from one or more proximal participant devices;
sending, over the network, a control signal to initiate recording of further imagery of the participant selected event with respective cameras associated with one or more proximal participant devices,
wherein, the further imagery is received at a server (19) to collate the imagery and sort the imagery in a sequence based on one or more of: position and/or orientation of the participant device (11) of the participant device associated with the further imagery; and recordal time associated with the further imagery, and wherein the server further generates a compiled imagery sequence based on the sequence of imagery.

19. The computer-implemented method according to claim 18, wherein the control signal to initiate is associated with timing data to synchronise cameras to record simultaneously or in a specified sequence.

20. The computer-implemented method according to either claim 18 or 19, further comprising:
forming a peer-to-peer network between the first participant device and the one or more proximal participant devices, wherein the invitations are communicated over the peer-to-peer network;
storing, in the memory of the first participant device and/or the proximal participant devices, the recorded imagery;
wherein on establishing network communication with the server, the first participant device and/or the proximal participant devices send the recorded imagery to the server.

21. The computer-implemented method according to any one of claims 18 to 20 further comprising: receiving, from the server, the compiled imagery sequence.

22. A non-transitory computer-readable medium comprising program instruction that, when executed, cause a processor of a participant device to perform the method according to any one of claims 18 to 21.
